(19) United States
(12) Patent Application Publication
(10) Pub. No.: US 2005/0041180 A1
(43) Pub. Date: Feb. 24, 2005

(54) Liquid crystal display device and electronic apparatus

(75) Inventor: Kinya Ozawa, Suwa-shi (JP)

Correspondence Address: OLIFF & BERRIDGE, PLC, P.O. BOX 19928, ALEXANDRIA, VA, 22320, US

(73) Assignee: SEIKO EPSON CORPORATION, TOKYO (JP)

(21) Appl. No.: 10/752,188

(22) Filed: Jan. 7, 2004

(30) Foreign Application Priority Data
Feb. 6, 2003 (JP) 2003-029416

(51) Int. Cl. G02F 1/1335; C09K 19/02

(52) U.S. Cl. 349/98; 349/178; 349/114

(57) ABSTRACT

To offer a transflective liquid crystal display device with a well-lit, a high contrast, and a wide viewing angle display, a liquid crystal display device has a liquid crystal layer disposed between a substrate and a substrate, and has a transmissive display area and a reflective display area. The liquid crystal layer is composed of liquid crystal with negative dielectric anisotropy, which represents vertical alignment in an initial state, and a circular polarizer is disposed on one side of each of the substrate and the substrate, the side being remote from the liquid crystal layer, to introduce circularly-polarized light into the liquid crystal layer. The circular polarizers include a retardation film and a retardation film, each satisfies Nz<1 when
Nz=(nx−nz)/(nx−ny) where refractive indices of two orthogonal axes in the plane of each of the retardation film and the retardation film are nx and ny, and a refractive index across the thickness is nz.

### BACKGROUND OF THE INVENTION

1. Field of the Invention

The present invention relates to liquid crystal display devices and electronic apparatuses. In particular, the present invention relates to a technique to provide a wide viewing angle in a transflective liquid crystal display device that operates in both reflective mode and transmissive mode.

2. Description of Related Art

As a liquid crystal display device, a transflective liquid crystal display device that combines a reflective mode and a transmissive mode is known in the related art. A transflective liquid crystal display device that has been proposed in the related art has a liquid crystal layer disposed between an upper substrate and a lower substrate, and a metal (e.g. aluminum) reflector being disposed inside the lower substrate, the metal reflector having a window for light transmission and functioning as a transflective film. In reflective mode, external light incident from the upper substrate side passes through the liquid crystal layer, is reflected at the reflector disposed inside the lower substrate, passes back through the liquid crystal layer, and is emitted from the upper substrate side for display. In transmissive mode, on the other hand, light from a backlight incident from the lower substrate side passes through the window of the reflector and the liquid crystal layer, and is emitted from the upper substrate side for display. In the reflector, therefore, the area with the window is a transmissive display area and the other area is a reflective display area.

A related art transflective liquid crystal display device, however, has a problem of a narrow viewing angle in transmissive display. Since a transflective film is disposed inside a liquid crystal cell to avoid parallax error, reflective display needs to be performed using only a polarizer disposed at a viewer's side. This results in limited flexibility in optical design. To address the above-mentioned problem, “Development of transflective LCD for high contrast and wide viewing angle by using homeotropic alignment,” M. Jisaki et al., Asia Display/IDW'01, p. 133-136 (2001) proposes a liquid crystal display device using liquid crystal with homeotropic alignment. Its characteristics are as follows:

1) A “vertical Alignment (VA) mode” is adopted. In this mode, liquid crystal with negative dielectric anisotropy is aligned normal to the substrates and tilted by applying a voltage.

2) A “multi-gap structure” is adopted. That is, the thicknesses of a transmissive display area and a reflective display area of a liquid crystal layer (cell gap) are different See e.g. Japanese Unexamined Patent Application Publication No. 11-242226.

3) A “multi-domain structure” is adopted. That is, a transmissive display area is arranged in a regular octagon, and a protrusion is provided in the center of the transmissive display area on a facing substrate to tilt the liquid crystal in eight directions within this area.

The paper presented by Jisaki et al. describes a circular polarizer that is a combination of a polarizer and a λ/4 retardation film, and is disposed outside of each substrate to introduce circularly-polarized light into a liquid crystal layer. While such characteristics of the circular polarizer significantly affect the viewing-angle characteristics, Jisaki et al., in their paper, do not specifically define the circular polarizer from that viewpoint. Gray-scale inversion may occur in the range of large viewing angle, and may cause degradation in the viewing-angle characteristics.

### SUMMARY OF THE INVENTION

The present invention is made to address the problem mentioned above. The present invention provides a transflective liquid crystal display device that can provide a wide viewing angle and can minimize the occurrence of gray-scale inversion.

To achieve an aspect of the present invention provides a liquid crystal display device having a liquid crystal layer disposed between a pair of substrates, a plurality of dot areas, each having a transmissive display area and a reflective display area, the liquid crystal layer being composed of liquid crystal with negative dielectric anisotropy, which represents vertical alignment in an initial state, a circular polarizer being disposed on one side of each substrate, the side being remote from the liquid crystal layer, to introduce circularly-polarized light into the liquid crystal layer, and each of the circular polarizers including a retardation film that satisfies Nz<1 when
Nz=(nx−nz)/(nx−ny),
refractive indices of two orthogonal axes in the plane of the retardation film being nx and ny, and a refractive index across the thickness being nz.

The liquid crystal display device according to an aspect of the present invention is a combination of a transflective liquid crystal display device and liquid crystal in vertical alignment mode, and specifies preferred conditions for the retardation film included in the circular polarizer to provide a wide viewing angle. That is, when the retardation film for introducing circularly-polarized light into the liquid crystal layer satisfies Nz<1, a wide viewing angle display can be provided, and gray-scale inversion occurring with changes in the level of voltage particularly applied to the liquid crystal layer can be reduced or prevented.

To achieve the above-mentioned objectives, moreover, an aspect of the present invention provides a liquid crystal display device having a liquid crystal layer disposed between a pair of substrates, a plurality of dot areas, each having a transmissive display area and a reflective display area, the liquid crystal layer being composed of liquid crystal with negative dielectric anisotropy, which represents vertical alignment in an initial state, a circular polarizer being disposed on one side of each substrate, the side being remote from the liquid crystal layer, to introduce circularly-polarized light into the liquid crystal layer, and each of the circular polarizers including a retardation film that satisfies Nz=1 when
Nz=(nx−nz)/(nx−ny),
refractive indices of two orthogonal axes in the plane of the retardation film being nx and ny, and a refractive index across the thickness being nz.

When the retardation film for introducing circularly-polarized light into the liquid crystal layer satisfies Nz=1, a wide viewing angle display can also be provided, and gray-scale inversion occurring with changes in voltage particularly applied to the liquid crystal layer can also be reduced or prevented.

The pair of substrates includes an upper substrate and an lower substrate. A backlight for transmissive display is disposed at one side of the lower substrate, i.e. the side being remote from the liquid crystal layer. At the other side of the lower substrate, i.e. the side adjacent to the liquid crystal layer, a reflector is selectively formed only in the reflective display area. An adjusting layer (e.g. a insulating layer) to adjust the thickness of the liquid crystal layer can be disposed in the reflective display area so that the thickness of the liquid crystal layer in the reflective display area can be smaller than that in the transmissive display area. The adjusting layer thus approximates or substantially equalizes the retardation in the reflective display area to the retardation in the transmissive display area, and thus can enhance contrast.

Second retardation films, each having an optical axis across the thickness, can be disposed between the liquid crystal layer and the circular polarizer. This widens a viewing angle of the liquid crystal display device. Each second retardation film satisfies nx₂=ny₂>nz₂ where refractive indices of two orthogonal axes in the plane of the second retardation film are nx₂ and ny₂, and a refractive index across the thickness is nz₂, and satisfies
0.45Rt≦(nx₂−nz₂)×d≦0.75Rt (1)
where d is the thickness of the second retardation film and Rt is the phase difference of the liquid crystal layer in the transmissive display area. The phase difference of the liquid crystal display device is double (nx₂−nz₂)×d because the second retardation films are disposed at both the upper substrate and the lower substrate of the liquid crystal display device.

Each of the circular polarizers is a combination of a polarizer and a λ/4 retardation film, the λ/4 retardation film satisfies the condition for Nz, and the wavelength dispersion of the λ/4 retardation film has reverse dispersion characteristics. For example, a retardation film where the ratio of in-plane phase-difference value R(450) at the phase difference of 450 nm to in-plane phase-difference value R(590) at the phase difference of 590 nm, i.e. R(450)/R(590), is less than 1, can be used. A high contrast display can thus be provided.

Each of the circular polarizers is a combination of a polarizer and a λ/4 retardation film, the λ/4 retardation film satisfies the condition for Nz, and the optical axis of the λ/4 retardation film and the polarization axis of the polarizer form an angle of about 45°. The polarization axis of a first polarizer disposed at one substrate side of the pair of substrates and a polarization axis of a second polarizer disposed at the other of the pair of substrates are substantially orthogonal, and the slow axis or the fast axis of a first λ/4 retardation film disposed at one substrate side of the pair of substrates and the slow axis or the fast axis of a second λ/4 retardation film disposed at the other of the pair of substrates are substantially orthogonal. This structure also contributes to providing a display with a high contrast.

Each of the circular polarizers includes a λ/2 retardation film and a λ/4 retardation film, and the λ/2 retardation film and the λ/4 retardation film satisfy the condition for Nz. This also contributes to providing a display with a high contrast. For a higher contrast, preferably the optical axis of the λ/2 retardation film and the polarization axis of the polarizer form an angle of 15°, and the optical axis of the λ/4 retardation film and the polarization axis of the polarizer form an angle of 75°, or preferably the optical axis of the λ/2 retardation film and the polarization axis of the polarizer form an angle of 17.5°, and the optical axis of the λ/4 retardation film and the polarization axis of the polarizer form an angle of 80°. Preferably, the polarization axis of a first polarizer disposed at one substrate side of the pair of substrates and the polarization axis of a second polarizer disposed at the other of the pair of substrates are substantially orthogonal, and each slow axis or fast axis of a first λ/2 retardation film and a first λ/4 retardation film that are disposed at one substrate side of the pair of substrates, and each slow axis or fast axis of a second λ/2 retardation film and a second λ/4 retardation film that are disposed at the other of the pair of substrates are substantially orthogonal.

In the liquid crystal display device according to an aspect of the present invention, a retardation film disposed at one substrate side of the pair of substrates may include a λ/2 retardation film and a ?/4 retardation film, and a retardation film disposed at the other of the pair of substrates may include a λ/4 retardation film. Even the composition of the retardation films are different, the effect of the present invention can be exerted, as far as each substrate satisfies the condition for Nz.

Next, an electronic apparatus of an aspect of the present invention is characterized as having the above-described liquid crystal display device. This electronic apparatus can provide a display with wide viewing angle and excellent display characteristics.

### BRIEF DESCRIPTION OF THE FIGURES

FIG. 1 is an equivalent circuit schematic of a liquid crystal display device according to a first exemplary embodiment of the present invention;

FIG. 2 is a plan view showing a dot structure of the liquid crystal display device according to the first exemplary embodiment of the present invention;

FIG. 3(A)-3(B) include a plan view and a cross-sectional view showing a main part of the liquid crystal display device according to the first exemplary embodiment of the present invention;

FIG. 4 is a schematic for illustrating anisotropy of reflective index of a retardation film;

FIG. 5 is a graph plotting transmittance versus viewing angle of the liquid crystal display device shown in FIG. 1;

FIG. 6 is a graph plotting transmittance versus viewing angle of the liquid crystal display device for comparison;

FIGS. 7(A)-7(B) include a diagrammatic plan view and a diagrammatic cross-sectional view showing a main part of a liquid crystal display device according to a second exemplary embodiment of the present invention;

FIGS. 8(A)-8(B) include schematics illustrating the viewing-angle characteristics of the liquid crystal display device shown in FIG. 7;

FIGS. 9(A)-9(C) include schematics illustrating changes in viewing angle characteristic of different retardation films in the liquid crystal display device shown in FIG. 7;

FIGS. 10(A)-10(B) include a schematic plan view and a schematic cross-sectional view showing a main part of a liquid crystal display device according to a third exemplary embodiment of the present invention;

FIG. 11 is a graph plotting transmittance versus viewing angle of the liquid crystal display device shown in FIG. 10;

FIG. 12 is a graph plotting transmittance versus viewing angle of the liquid crystal display device for comparison; and

FIG. 13 is a perspective view showing an example of the electronic apparatus according to an aspect of the present invention.

### DETAILED DESCRIPTION OF PREFERRED EMBODIMENTS

First Exemplary Embodiment

A first exemplary embodiment of the present invention will now be described with reference to the figures.

A liquid crystal display device of the present exemplary embodiment is an active matrix liquid crystal display device using a thin film transistor (hereinafter “TFT”) as a switching device.

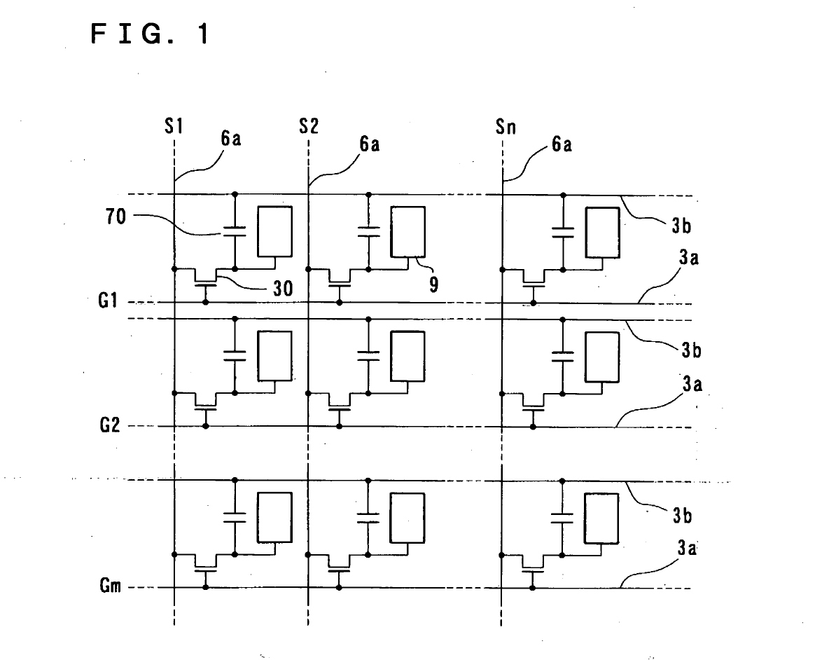

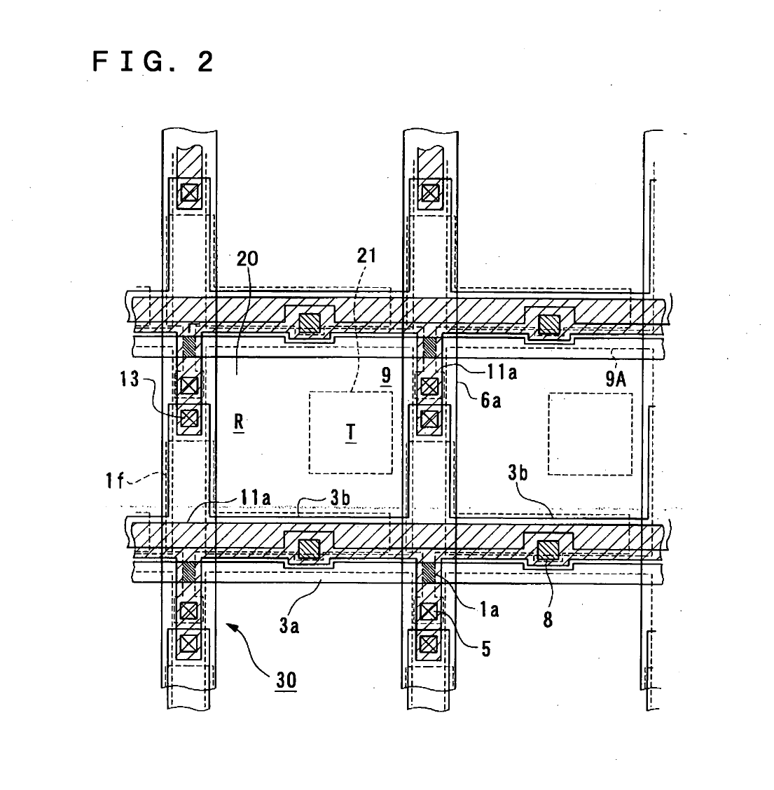

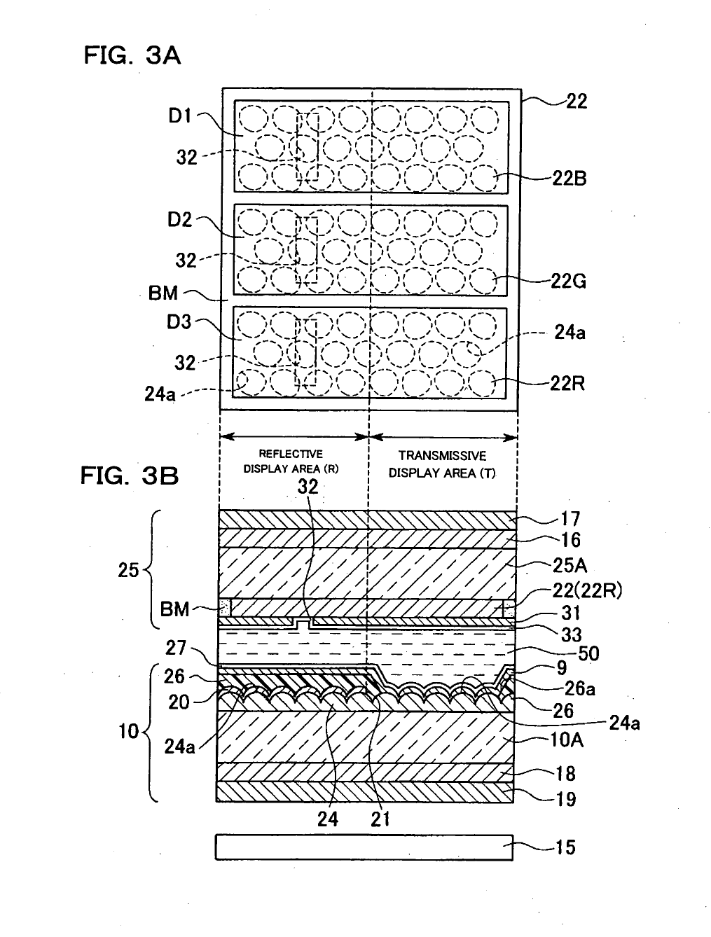

FIG. 1 is an equivalent circuit schematic of a plurality of dots that are arranged in a matrix and that form an image display area of the liquid crystal display device according to the present exemplary embodiment. FIG. 2 is a plan view showing a structure of neighboring dots of a TFT array substrate. FIGS. 3(A) and 3(B) are a plan view (upper) and a cross-sectional view (lower) showing the structure of a liquid crystal display device. In each figure below, each layer and each member are shown at different scales for better viewability.

In the liquid crystal display device of the present exemplary embodiment, as shown in FIG. 1, each of a plurality of dots that are arranged in a matrix and that form an image display area includes a pixel electrode 9 and a TFT 30 functioning as a switching device to control the pixel electrode 9. A data line 6a to which an image signal is supplied is electrically connected to a source of the TFT 30. Image signals S1, S2, . . . , and Sn written into the data lines 6a are line-sequentially supplied in this order, or are supplied to neighboring data lines 6a in a group. A scanning line 3a is electrically connected to a gate of the TFT 30. Scanning signals G1, G2, . . . , and Gm are line-sequentially applied to a plurality of scanning lines 3a in pulses at predetermined timing. The pixel electrode 9 is electrically connected to a drain of the TFT 30, and writes each image signal S1, S2, . . . , and Sn from each data line 6a into liquid crystal at a predetermined timing, by turning the TFT 30 functioning as a switching device ON for a certain period of time.

Predetermined levels of the image signals S1, S2, . . . , and Sn written into the liquid crystal via the pixel electrode 9 are retained, for a certain period of time, in a region with a common electrode, which is described below. The liquid crystal changes its alignment and order of molecules with the level of voltage applied, thus modulating light, and providing grayscale levels. To reduce or prevent leakage of the image signals retained, a storage capacitor 70 is added in parallel with a liquid crystal capacitance formed between the pixel electrode 9 and the common electrode. The reference numeral 3b is a capacitor line.

Referring now to FIG. 2, the planar structure of a TFT array substrate included in the liquid crystal display device according to the present exemplary embodiment will be described.

On the TFT array substrate, as shown in FIG. 2, a plurality of the square pixel electrodes 9 (dotted lines 9A show their shapes) are arranged in a matrix. The data lines 6a are along vertical boundaries of the pixel electrodes 9, and the scanning lines 3a and the capacitor lines 3b are along horizontal boundaries of the pixel electrodes 9. In the present exemplary embodiment, the pixel electrode 9 and an area surrounded by the data line 6a, the scanning line 3a, the capacitor line 3b, and etc. constitute one dot area. Each of the dot areas arranged in a matrix has a display function.

The data line 6a is electrically connected via a contact hole 5 to a source area (described below) in a semiconductor layer 1a included in the TFT 30 and made of, e.g., a polysilicon film. The pixel electrode 9 is electrically connected via a contact hole 8 to a drain area (described below) in the semiconductor layer 1a. The scanning line 3a is opposed to a channel area (an area with diagonal lines from the upper left to the lower right) in the semiconductor layer 1a. The scanning line 3a functions as a gate electrode at a position opposing the channel area.

The capacitor line 3b has a main-line part (i.e. in plan view, a first area formed along the scanning line 3a) extending along the scanning line 3a in a substantially straight line, and a projecting part along the data line 6a (i.e. in plan view, a second area formed along the data line 6a) extending from an intersection with the data line 6a to previous rows (the upward direction in FIG. 2).

In FIG. 2, areas with diagonal lines from the lower left to the upper right indicate a plurality of first shielding filters 11a.

In particular, each shielding filter 11a covers the TFT 30 including the channel area of the semiconductor layer 1a when viewed from the TFT array substrate. The shielding filter 11a has a main-line part opposing the main-line part of the capacitor line 3b and extending along the scanning line 3a in a straight line, and a projecting part along the data line 6a extending from an intersection with the data line 6a to subsequent rows (the downward direction in FIG. 2). Each end of downward projecting parts of the shielding filter 11a in each row (pixel line) overlaps, under the data line 6a, with each end of upward projecting parts of the capacitor line 3b in the next row. This overlapping area has a contact hole 13 to electrically connect the shielding filter 11a and the capacitor line 3b. That is, in the present exemplary embodiment, the shielding filter 11a is electrically connected to the capacitor line 3b in the previous row or the subsequent row by the contact hole 13.

A reflector 20 is formed in each dot area, as shown in FIG. 2. Each dot area has a reflective display area R where the reflector 20 is formed, and a transmissive display area T where no reflector 20 is formed, i.e. an area within an opening 21 of the reflector 20.

Referring now to FIGS. 3(A) and (B), the planar structure and the cross-sectional structure of the liquid crystal display device according to the present exemplary embodiment will be described. FIG. 3(A) is a plan view showing the planar structure of color filter layers included in the liquid crystal display device of the present exemplary embodiment. FIG. 3(B) is a cross-sectional view showing a portion corresponding to a red layer of the plan view in FIG. 3(A).

As shown in FIG. 2, the liquid crystal display device according to the present exemplary embodiment has dot areas, each dot area including a pixel electrode 9 surrounded by the data line 6a, the scanning line 3a, capacitor line 3b, and the like. Each dot area, as shown in FIG. 3(a), has a colored layer corresponding to one of three primary colors, and three dot areas (D1, D2, and D3) form pixels that include colored layers 22B (blue), 22G (green), and 22R (red).

As shown in FIG. 3(B), in the liquid crystal display device of the present exemplary embodiment, a TFT array substrate 10 and a facing substrate 25 being opposed thereto sandwich liquid crystal which is vertically aligned in an initial state, i.e. a liquid crystal layer 50 composed of a liquid crystal material with negative dielectric anisotropy. In the TFT array substrate 10, a reflector 20, which is composed of a metal with high reflectance, such as aluminum and silver, is partially formed on the surface of a main substrate 10A, which is composed of a translucent material, such as quartz and glass, with an insulating film 24 provided therebetween. As described above, an area where the reflector 20 is formed is the reflective display area R and an area where no reflector 20 is formed, i.e. an area within the opening 21 of the reflector 20, is the transmissive display area T. The liquid crystal display device according to the present exemplary embodiment is a vertical alignment type liquid crystal display device, in which the liquid crystal layer 50 is of the vertically aligned type, and is a transflective type liquid crystal display device which is capable of both reflective display and transmissive display.

The insulating film 24 formed on the main substrate 10A has surface irregularities 24a, and the reflector 20 on the surface of the insulating film 24 also has surface irregularities.

Since reflective light is scattered by such irregularities, reflection from the outside can be reduced or prevented, and wide viewing angle display can be achieved.

An insulating film 26 is formed on the reflector 20 and corresponds to the reflective display area R. That is, the insulating film 26 is selectively formed on the reflector 20 and makes the thickness of the liquid crystal layer 50 in the reflective display area R different from the thickness of the liquid crystal layer 50 in the transmissive display area T according to forming of the insulating film 26. The insulating film 26 has a thickness of, for example, about 2 to 3 μm and is composed of organic material, such as acrylic resin. At the boundary between the reflective display area R and the transmissive display area T, the insulating film 26 has an inclined area with an inclined surface 26a to continuously change the thickness thereof. In an area where no insulating film 26 is formed, the liquid crystal layer 50 has a thickness of about 4 to 6 μm. The thickness of the liquid crystal layer 50 in the reflective display area R is about half the thickness of the liquid crystal layer 50 in the transmissive display area T.

As described above, the insulating film 26 functions as an adjusting layer that makes the thickness of the liquid crystal layer 50 in the reflective display area R different from the thickness of the liquid crystal layer 50 in the transmissive display area T. In the present exemplary embodiment, the edge of the upper flat surface of the insulating film 26 substantially coincides with the edge of the reflector 20 (reflective display area). The inclined area of the insulating film 26 is thus included in the transmissive display area T.

On the surface of the TFT array substrate 10 including the surface of the insulating film 26, the pixel electrode 9 made of a transparent conductive film, such as indium tin oxide (hereinafter abbreviated as ITO) and an alignment film 27 made of, e.g., polyimide are formed. While the reflector 20 and the pixel electrode 9 are separately disposed and stacked in layers in the present exemplary embodiment, a metal reflector can be used as a pixel electrode in the reflective display area R.

In the transmissive display area T, the insulating film 24 is formed on the main substrate 10A. On the surface of the insulating film 24, the reflector 20 and the insulating film 26 are not formed, but the pixel electrode 9 and the alignment film 27 made of, e.g., polyimide are formed, instead.

In the facing substrate 25, a color filter 22 (a red layer 22R in FIG. 3(b)) is disposed on a main substrate 25A (the liquid crystal layer side of the main substrate 25A) composed of translucent material, such as quartz or glass. The red layer 22R is surrounded by a black matrix BM that forms the boundaries of each dot area D1, D2, and D3(see FIG. 3(a)).

A common electrode 31 made of a transparent conductive film, such as ITO and an alignment film 33 made of, e.g., polyimide are formed at the liquid crystal layer side of the color filter 22. The common electrode 31 has a concave portion 32 formed in the reflective display area R. A concave portion (a step) is formed substantially along the concave portion 32 on the surface of the alignment film 33, that is, on the surface interposed between the alignment film 33 and the liquid crystal layer 50. The concave portion (the step) has inclined surfaces forming predetermined angles with the planes of the substrates (or with the directions of the vertically aligned liquid crystal molecules). The alignment of the liquid crystal molecules, in particular, the tilt directions of the vertically aligned liquid crystal molecules in the initial state, are determined by the directions of the inclined surfaces. In the present exemplary embodiment, both the alignment film 27 and the alignment film 33 of the TFT array substrate 10 and the facing substrate 25, respectively, are processed for vertical alignment.

A retardation film 18 and a polarizer 19 are disposed at the outer side of the TFT array substrate 10 (i.e. the side remote from the liquid crystal layer 50) and a retardation film 16 and a polarizer 17 are disposed at the outer side of the facing substrate 25, to introduce circularly-polarized light into inside surfaces of the substrates (i.e. the sides adjacent to the liquid crystal layer 50). The retardation film 18 and the polarizer 19 constitute a circular polarizer, and the retardation film 16 and the polarizer 17 constitute another circular polarizer.

The polarizer 17 (19) allows only linearly-polarized light having a polarization axis in a predetermined direction to pass through, and a λ/4 retardation film is adopted as the retardation film 16 (18).

A backlight 15, functioning as a light source for transmissive display, is disposed outside of the polarizer 19 formed on the TFT array substrate 10.

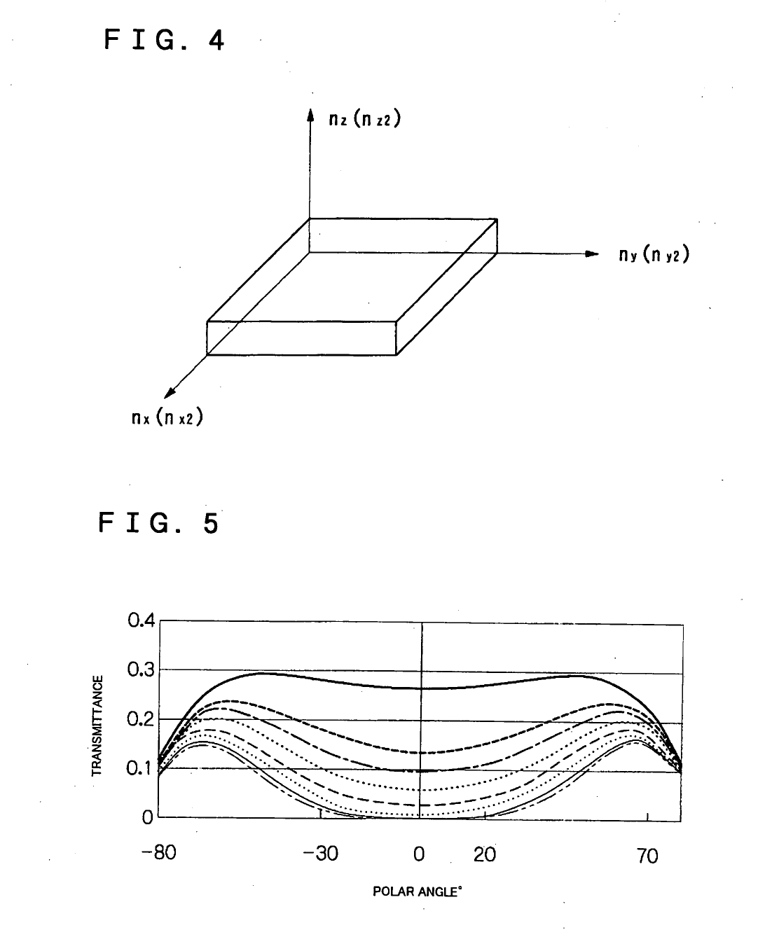

As shown in FIG. 4, the λ/4 retardation film 16 (18) satisfies Nz≦1, and in particular, Nz=0.5 when
Nz=(nx−nz)/(nx−ny)
where the refractive indices of the two orthogonal axes in the plane of the λ/4 retardation film 16 (18) are nx and ny, and the refractive index across the thickness is nz.

In the liquid crystal display device according to the present exemplary embodiment, the insulating film 26 disposed in the reflective display area R reduces the thickness of the liquid crystal layer 50 in the reflective display area R to about half the thickness of the liquid crystal layer 50 in the transmissive display area T. Thus, the retardation in the reflective display area R and the retardation in the transmissive display area T are substantially equal, and thus, the contrast can be enhanced.

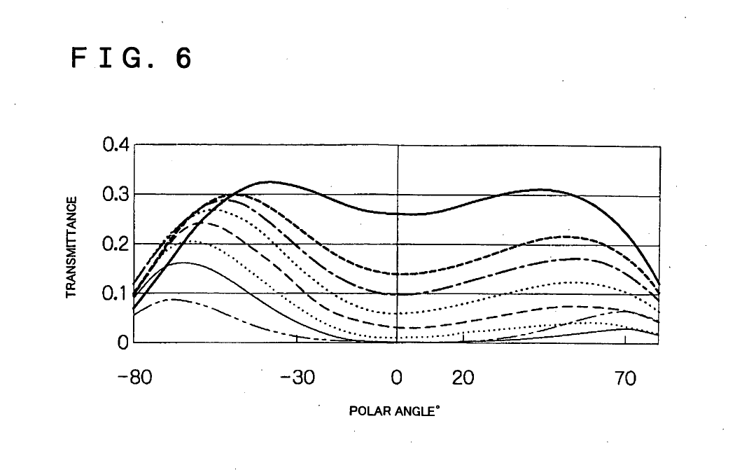

The liquid crystal display device according to the present exemplary embodiment provides a display with a wide viewing angle. FIG. 5 is a graph illustrating viewing-angle dependence of the liquid crystal display device (Nz=0.5) according to the present exemplary embodiment. FIG. 6 is a graph illustrating viewing-angle dependence of a liquid crystal display device (Nz=1.1) that is outside the scope of the present invention. In each graph, the vertical axis represents transmittance, and the horizontal axis represents viewing angle (polar angle) when viewed from directions deviating from the normal to the substrate surface. Each curve represents data taken under different voltage levels. The curves exhibiting higher transmittance levels at a polar angle of 0° correspond to data taken under high voltage levels.

In the present exemplary embodiment, as shown in FIG. 5, the level of transmittance increases with the level of voltage applied, even when viewed from the side. This shows that a display with no gray-scale inversion is achieved. FIG. 6, on the other hand, shows that when Nz=1.1, an inversion of transmittance occurs at the gray levels near the white display mode, when viewed from the side, e.g., at an angle of about −50°. This indicates the occurrence of gray-scale inversion. The above description shows that when Nz≦1 according to the present exemplary embodiment, a display with a wide viewing angle can be provided without gray-scale inversion.

According to the present exemplary embodiment, the wavelength dispersion of the λ/4 retardation film 16 (18) exhibits reverse dispersion characteristics. For example, the λ/4 retardation film 16 (18), where the ratio of in-plane phase-difference value R(450) at the phase difference of 450 nm to in-plane phase-difference value R(590) at the phase difference of 590 nm, i.e. R(450)/R(590), is less than 1, is used. A display with a high contrast can thus be provided. Further, the optical axis of the λ/4 retardation film 16 (18) and the polarization axis of the polarizer 17 (19) form an angle of about 45°. The polarization axis of the polarizer 17 disposed at the side adjacent to the facing substrate 25 and the polarization axis of the polarizer 19 disposed at the side adjacent to the TFT array substrate 10 are substantially orthogonal. The slow axis or the fast axis of the λ/4 retardation film 16 disposed at the side adjacent to the facing substrate 25 and the slow axis or the fast axis of the λ/4 retardation film 18 disposed at the side adjacent to the TFT array substrate 10 are substantially orthogonal. Thus, a display with a higher contrast can be provided.

Second Exemplary Embodiment

A second exemplary embodiment of the present invention will now be described with reference to the figures.

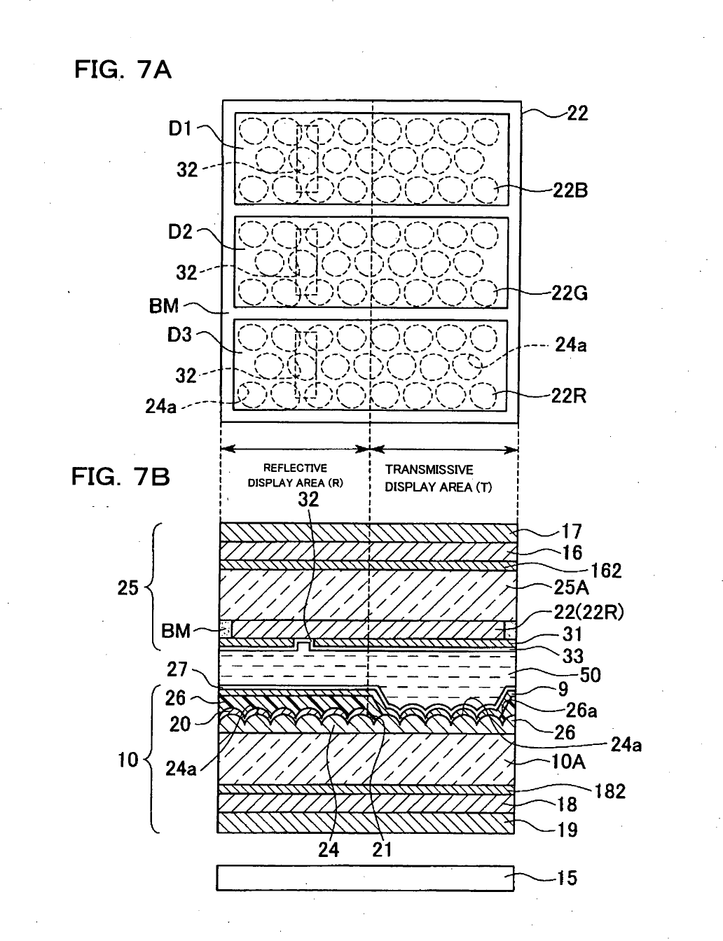

FIGS. 7(A) and 7(B) include a plan view and a cross-sectional view that illustrate a liquid crystal display device of the second exemplary embodiment, and corresponds to FIGS. 3(A) and 3(B) of the first exemplary embodiment. The basic structure of the liquid crystal display device of the present exemplary embodiment is the same as that of the first exemplary embodiment, except that a viewing-angle compensator 162 (182) made of a C plate (i.e. a retardation film having an optical axis across the film thickness) is disposed at the liquid crystal layer 50 side of the λ/4 retardation film 16 (18). The components appearing in both FIGS. 3(A) and 3(B) and FIGS. 7(A) and 7(B) are indicated by the same numerals, and detailed descriptions thereof will be omitted.

In the present exemplary embodiment, as shown in FIGS. 7(A) and 7(B), the viewing-angle compensator 162 (182) is disposed at the liquid crystal layer 50 side of the λ/4 retardation film 16 (18). The phase difference in the liquid crystal layer 50 is 400 nm, the phase difference in the viewing-angle compensator 162 (182) is 200 nm, and Nz is 1.0. The liquid crystal display device with the viewing-angle compensator 162 (182) contributes to providing a display with a wide viewing angle.

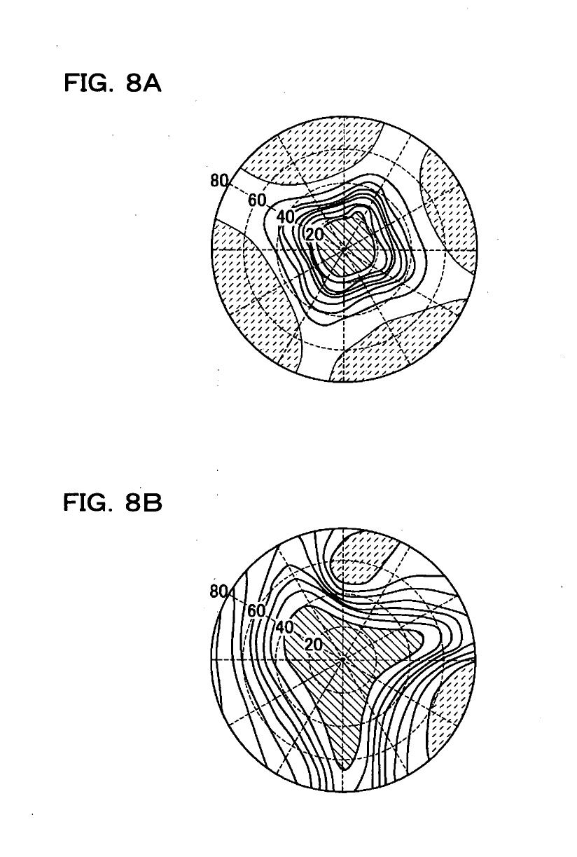

FIG. 8(A) is a schematic showing the contrast at each viewing angle for the liquid crystal display device without a viewing-angle compensator (for comparison). FIG. 8(B) is a schematic showing the contrast at each viewing angle for the liquid crystal display device with the viewing-angle compensator 162 (182) according to the present exemplary embodiment. The contours in solid lines show the same contrast values, the circumferential directions represent azimuth angle, and the radial directions represent polar angles to illustrate the distribution of the contrast values.

In the figures, the areas hatched with solid lines indicate a contrast value of 80 and above, and the areas hatched with broken lines indicate a contrast value of 10 and below. The use of the viewing-angle compensator 162 (182) thus expands the area indicating a contrast value of 10 and above, and widens the viewing angle.

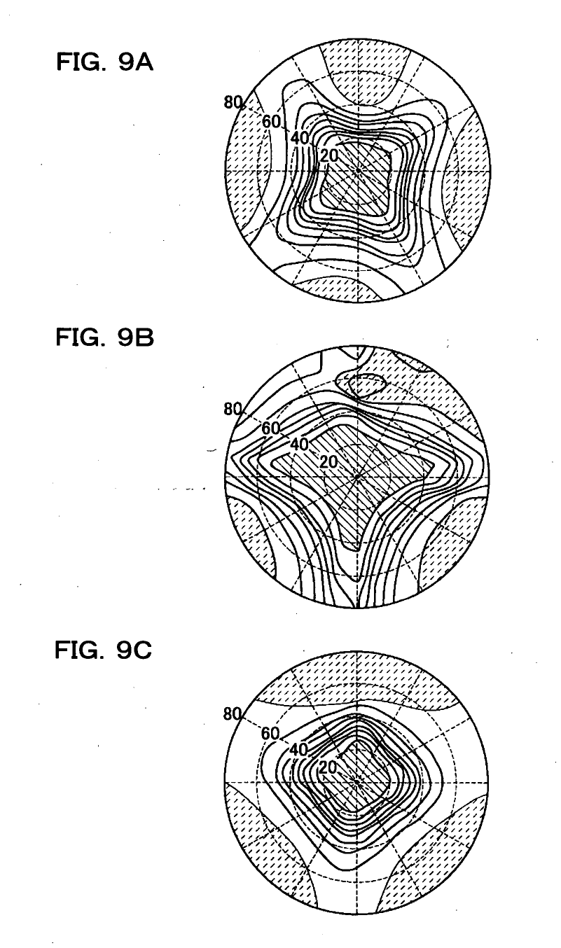

FIGS. 9(A)-9(C) similarly show the change in viewing angle when the phase difference of the viewing-angle compensator 162 (182) is 160 nm, 220 nm, and 310 nm. FIG. 9(A), FIG. 9(B) and FIG. 9(C) illustrate the viewing-angle characteristics when the phase differences are 310 mm, 220 nm, and 160 nm, respectively. FIGS. 9(A)-(C) show that a wider viewing angle can be provided when the phase difference in the viewing-angle compensator 162 (182) is 220 nm. That is, when the phase difference of the viewing-angle compensator 162 (182) is 220 nm, there are some areas indicating contrast values of 10 and above even at a cone angle of 60° and above. When the phase difference of the viewing-angle compensator 162 (182) is 160 nm or 310 nm, on the other hand, there are still some areas indicating contrast values of 10 and below even at a cone angle of 60° and below.

The viewing-angle characteristics of the liquid crystal display device are enhanced, when the phase difference of the viewing-angle compensator 162 (182) is ½ to ¾ that of the liquid crystal layer 50 (400 nm in this case). Further, the use of the viewing-angle compensator 162 (182) can effectively reduce or prevent the occurrence of gray-scale inversion.

Third Exemplary Embodiment

A third exemplary embodiment of the present invention will now be described.

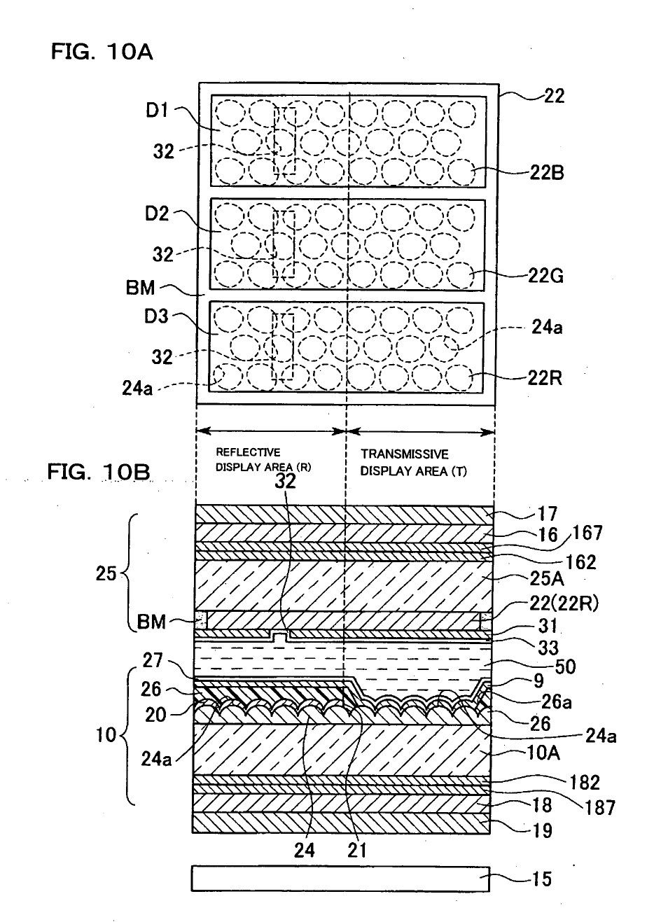

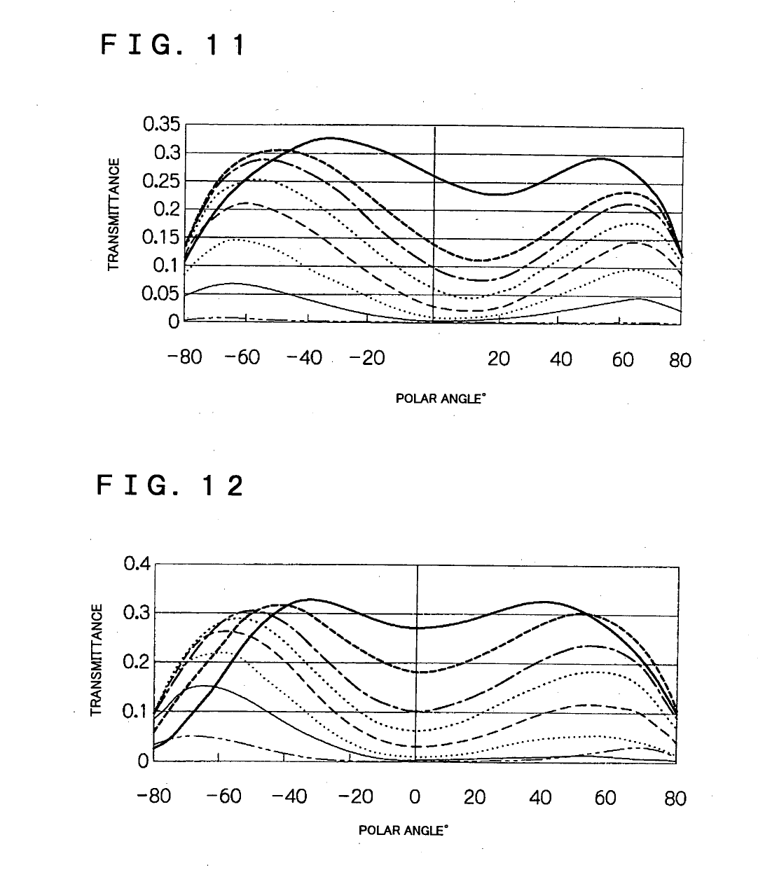

FIGS. 10(A)-10(B) include a plan view and a cross-sectional view that illustrate a liquid crystal display device of the third exemplary embodiment, and corresponds to FIG. 3 of the first exemplary embodiment. The basic structure of the liquid crystal display device of the present exemplary embodiment is the same as that of the first exemplary embodiment, except that a λ/2 retardation film 167 (187) and a viewing-angle compensator 162 (182) made of a C plate (i.e. a retardation film having an optical axis across the film thicknesses) are disposed at the liquid crystal layer 50 side of the λ/4 retardation films 16 (18). The components appearing in both FIG. 3 and FIG. 10 are indicated by the same numerals, and detailed descriptions thereof will be omitted.

In the present exemplary embodiment, as shown in FIGS. 10(A)-10(B), the λ/2 retardation film 167 (187) is disposed at the liquid crystal layer 50 side of the λ/4 retardation film 16 (18), and the viewing-angle compensator 162 (182) is also disposed at the liquid crystal layer 50 side of the λ/4 retardation film 16 (18). The phase difference in the liquid crystal layer 50 is 400 nm, and the phase difference in the viewing-angle compensator 162 (182) is 200 nm. Nz for both the λ/2 retardation film 167 (187) and the λ/4 retardation film 16 (18) is 0.5. Each polarization axis of the polarizer 17 and the polarizer 19 are orthogonal, the optical axis of the λ/2 retardation film 167 (187) and the polarization axis of the polarizer 17 (19) form an angle of 15°, and the optical axis of the λ/4 retardation film 16 (18) and the polarization axis of the polarizer 17 (19) form an angle of 75°. Each slow axis of the upper retardation films, i.e. the λ/4 retardation film 16 and the λ/2 retardation film 167, and each slow axis of the lower retardation films, i.e. the λ/4 retardation film 18 and the λ/2 retardation film 187, are substantially orthogonal.

When the applied voltage is OFF (the selection voltage is not applied), in this structure, the polarization is in the orthogonal state and blocks light from the backlight 15. The contrast can thus be enhanced, and in particular, can increase by about 10% compared to the case when the polarization is in the parallel state.

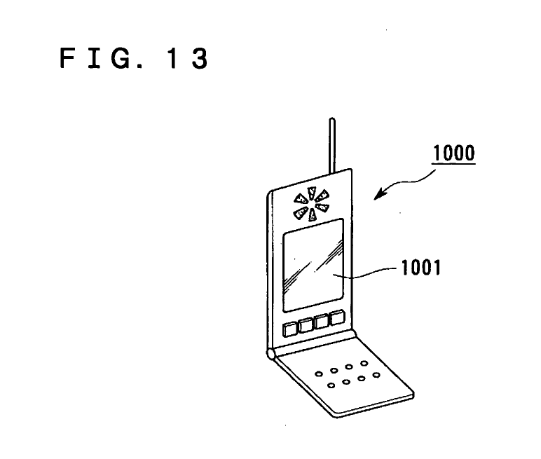

FIG. 11 is a graph illustrating viewing-angle dependence of the liquid crystal display device (Nz for both the λ/2 retardation film 167 (187) and the λ/4 retardation film 16 (18) is 0.5) according to the present exemplary embodiment. FIG. 12 is a graph illustrating viewing-angle dependence of a liquid crystal display device (Nz for both the λ/2 retardation film 167 (187) and the λ/4 retardation film 16 (18) is 1.1) that is outside the scope of the present invention. In each graph, the vertical axis represents transmittance, and the horizontal axis represents viewing angle (polar angle) when viewed from the side. Each curve represents data taken under different voltage levels. The curves exhibiting higher transmittance levels at a polar angle of 0° correspond to data taken under high voltage levels.

In the present exemplary embodiment, as shown in FIG. 11, the level of transmittance increases with the level of voltage applied (with a partial exception), even when viewed from the side. This shows that a display with a minimized occurrence of gray-scale inversion is achieved. FIG. 12, on the other hand, shows that when Nz=1.1, an inversion of transmittance at the gray levels near the white display mode is significant, when viewed from the side, e.g., at an angle of about −50°. This indicates the occurrence of gray-scale inversion. The above description shows that when Nz≦1 according to the present exemplary embodiment, a display with a wide viewing angle can be provided without gray-scale inversion.

Electronic Apparatus

An electronic apparatus having the liquid crystal display device according to the above exemplary embodiments of the present invention will now be described.

FIG. 13 is a perspective view showing an example of a mobile phone. The reference numeral 1000 shows a main body of the mobile phone, and the reference numeral 1001 shows a display using the liquid crystal display device described above. The use of the liquid crystal display device in such a mobile phone, according to the above exemplary embodiments, can contribute to achieving the electronic apparatus with a high intensity regardless of the environment for the usage, a high contrast, and a wide viewing angle.

The scope of the present invention is not limited to the embodiments shown above, but various modifications can be made within the spirit and the scope of the present invention. While the present invention, in the above exemplary embodiments, is applied to an active matrix liquid crystal display device using a TFT functioning as a switching device, the present invention can also be applied to an active matrix liquid crystal display device or a passive matrix liquid crystal display device using a thin film diode (TFD) functioning as a switching device. Particulars of materials, sizes, shapes, and etc. of various components can also be changed.

1. A liquid crystal display device, comprising:
a liquid crystal layer disposed between a pair of substrate; and
a plurality of dot areas, each having a transmissive display area and a reflective display area,
the liquid crystal layer being composed of liquid crystal with negative dielectric anisotropy, which represents vertical alignment in an initial state,
a circular polarizer being disposed on one side of each substrate, the side being remote from the liquid crystal layer, to introduce circularly-polarized light into the liquid crystal layer; and
each of the circular polarizers including a retardation film that satisfies Nz≦1 when
Nz=(nx−nz)/(nx−ny),
refractive indices of two orthogonal axes in the plane of the retardation film being nx and ny, and a refractive index across the thickness being nz.

2. The liquid crystal display device according to claim 1, further comprising:
second retardation films, each being disposed between the liquid crystal layer and the circular polarizer and having an optical axis across the thickness.

3. A liquid crystal display device, comprising:
a liquid crystal layer disposed between a pair of substrates; and
a plurality of dot areas, each having a transmissive display area and a reflective display area,
the liquid crystal layer being composed of liquid crystal with negative dielectric anisotropy, which represents vertical alignment in an initial state,
a circular polarizer being disposed on one side of each substrate, the side being remote from the liquid crystal layer, to introduce circularly-polarized light into the liquid crystal layer;
each of the circular polarizers including a retardation film that satisfies Nz=1 when
Nz=(nx−nz)/(nx−ny),
.+3
refractive indices of two orthogonal axes in the plane of the retardation film being nx and ny, and a refractive index across the thickness being nz; and
second retardation films, each being disposed between the liquid crystal layer and the circular polarizer and having an optical axis across the thickness.

4. The liquid crystal display device according to claim 2, each second retardation film satisfying nx₂=ny₂>nz₂, refractive indices of two orthogonal axes in the plane of the second retardation film being nx₂ and ny₂, and a refractive index across the thickness being nz₂, and satisfies
0.45Rt≦(nx₂−nz₂)×d≦0.75Rt,
d being the thickness of the second retardation film and Rt being the phase difference of the liquid crystal layer in the transmissive display area, and the phase difference of the liquid crystal display device being double (nx₂−nz₂)×d because the second retardation films are disposed at both the upper substrate and the lower substrate of the liquid crystal display device.

5. The liquid crystal display device according to claim 1, each of the circular polarizers being a combination of a polarizer and a λ/4 retardation film, the λ/4 retardation film satisfying the condition for Nz, and the wavelength dispersion of the λ/4 retardation film exhibiting reverse dispersion characteristics.

6. The liquid crystal display device according to claim 1, each of the circular polarizers being a combination of a polarizer and a λ/4 retardation film, the λ/4 retardation film satisfying the condition for Nz, and the optical axis of the λ/4 retardation film and the polarization axis of the polarizer forming an angle of about 45°.

7. The liquid crystal display device according to claim 1, each of the circular polarizers being a combination of a polarizer and a λ/4 retardation film, the λ/4 retardation film satisfying the condition for Nz, the polarization axis of a first polarizer disposed at one substrate side of the pair of substrates and the polarization axis of a second polarizer disposed at the other of the pair of substrates being substantially orthogonal, and the slow axis (or the fast axis) of a first λ/4 retardation film disposed at one substrate side of the pair of substrates and the slow axis (or the fast axis) of a second λ/4 retardation film disposed at the other of the pair of substrates being substantially orthogonal.

8. The liquid crystal display device according to claim 1, each of the circular polarizers including a λ/2 retardation film and a λ/4 retardation film, and the λ/2 retardation film and the λ/4 retardation film satisfying the condition for Nz.

9. The liquid crystal display device according to claim 8, the optical axis of the λ/2 retardation film and the polarization axis of the polarizer forming an angle of 15°, and the optical axis of the λ/4 retardation film and the polarization axis of the polarizer forming an angle of 75°.

10. The liquid crystal display device according to claim 8, wherein the optical axis of the λ/2 retardation film and the polarization axis of the polarizer forming an angle of 17.5°, and the optical axis of the λ/4 retardation film and the polarization axis of the polarizer forming an angle of 80°.

11. The liquid crystal display device according to claim 9, the polarization axis of a first polarizer disposed at one substrate side of the pair of substrates and the polarization axis of a second polarizer disposed at the other of the pair of substrates being substantially orthogonal, and each slow (or fast) axis of a first λ/2 retardation film and a first λ/4 retardation film that are disposed at one substrate side of the pair of substrates, and each slow (or fast) axis of a second λ/2 retardation film and a second λ/4 retardation film that are disposed at the other of the pair of substrates being substantially orthogonal.

12. The liquid crystal display device according to claim 1, a retardation film disposed at one substrate side of the pair of substrates including a λ/2 retardation film and a λ/4 retardation film, and a retardation film disposed at the other of the pair of substrates including a λ/4 retardation film.

13. An electronic apparatus having a liquid crystal display device according to claim 1.
